(19) United States
(12) Patent Application Publication
(10) Pub. No.: US 2008/0134196 A1
(43) Pub. Date: Jun. 5, 2008

(54) Apparatus, System, and Method of a Memory Arrangement for Speculative Multithreading

(75) Inventors: Carlos Madriles, Barcelona (ES); Peter Rundberg, Goteborg (SE); Jesus Sanchez, Barcelona (ES); Carlos Garcia, Barcelona (ES); Pedro Marcuello, Barcelona (ES); Antonio Gonzalez, Barcelona (ES)

Correspondence Address: PEARL COHEN ZEDEK LATZER, LLP, 1500 BROADWAY, 12TH FLOOR, NEW YORK, NY, 10036, US

(73) Assignee: INTEL CORPORATION, SANTA CLARA CALIFORNIA (CA)

(21) Appl. No.: 10/544,874

(22) PCT Filed: May 19, 2005
(86) PCT No.: PCT/ES05/00279

§ 371 Date: Aug. 9, 2005

(51) Int. Cl. G06F 9/46

(52) U.S. Cl. 718/106

(57) ABSTRACT

The invention relates to a multiversion storage configuration which can store multiple values per speculative set of instructions for one storage position in order to enable the real-time precalculation and execution of the body of the set of instructions from a speculative instruction set. The invention also relates to the validation of the input values which can be calculated and used in the execution of the speculative instruction set. The invention further relates to a method of performing said validation step.

### BACKGROUND OF THE INVENTION

A speculative thread in a speculative multithreading architecture may include a thread body and a pre-computation slice. The term “thread”, as used herein, may refer to a set of one or more instructions. The term “speculative thread”, as is well known in the art, may refer to a thread that is executed based on speculative input conditions. A speculative thread can become committed after validation of its input conditions. The pre-computation slice of a speculative thread may include a subset of instructions from a spawning thread that spawned the speculative thread. Data dependencies between the spawning thread and the spawned thread may be handled by the pre-computation slice of the spawned thread. During execution of the speculative thread, the pre-computation slice may be executed to produce one or more “live-in” input values that are consumed by the thread body of the speculative thread.

To produce the live-in input values, the pre-computation slice of a speculative thread may require access to certain “old” memory values, e.g., values from the time when the thread was spawned rather than the most recently produced values for that thread. However, other parts of the speculative thread, for example, the thread body of the thread, may require access to memory values that are updated most recently. Therefore, a speculative multithreading architecture with live-in pre-computation may require a memory configuration or memory arrangement that is able to support both the pre-computation slice and the thread body of a speculative thread.

### BRIEF DESCRIPTION OF THE DRAWINGS

The invention will be understood and appreciated more fully from the following detailed description of various embodiments of the invention, taken in conjunction with the accompanying drawings of which:

FIG. 1 is a block diagram illustration of an apparatus adapted to execute a computer program code by speculative multithreading with live-in pre-computation according to at least one embodiment of the invention;

FIG. 2 is a block diagram illustration of a thread unit having a memory configuration adapted to support multi-versioning and a processing unit executing a speculative thread according to illustrative embodiments of the invention;

FIG. 3 is a schematic flowchart of a method of spawning a thread according to illustrative embodiments of the invention;

FIG. 4 is a schematic flowchart of a method of executing the pre-computation slice of a speculative thread according to illustrative embodiments of the invention;

FIG. 5 is a schematic flowchart of a method of executing the thread body of a speculative thread according to illustrative embodiments of the invention;

FIG. 6 is a schematic flowchart of a method of executing a load instruction in a pre-computation slice according to illustrative embodiments of the invention;

FIG. 7 is a schematic flowchart of a method of executing a store instruction in a pre-computation slice according to illustrative embodiments of the invention;

FIG. 8 is a schematic flowchart of a method of executing a load instruction in the thread body of a speculative thread according to illustrative embodiments of the invention; and

FIG. 9 is a schematic flowchart of a method of executing a store instruction in the thread body of a speculative thread according to illustrative embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in older to provide a thorough understanding of embodiments of the invention. However it will be understood by those of ordinary skill in the art that embodiments of the invention may be practiced without these specific details In other instances, well-known methods and procedures have not been described in detail so as not to obscure the embodiments of the invention.

Some portions of the detailed description in the following are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Some embodiments of the invention may be implemented, for example, using a machine-readable medium or article which may store an instruction or a set of instructions that, if executed by a machine, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software.

The machine-readable medium or article may include, for example, any suitable type of memory unit, memory structure, memory article, memory medium, storage device, storage article, storage medium and/or storage unit, e.g., memory, removable or non-removable media, erasable or non-erasable media, writeable or rewriteable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like.

The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Embodiments of the invention may include apparatuses for performing the operations herein. These apparatuses may be specially constructed for the desired purposes, or they may include a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROM), random access memories (RAM), electrically programmable read-only memories (EPROM), electrically erasable and programmable read only memories (EEPROM), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the invention are not described with reference to any particular programming language. It will be appreciated that a variety of programming languages may be used to implement the teachings of the invention as described herein.

In the following description, various figures, diagrams, flowcharts, models, and descriptions are presented as different means to effectively convey the substances and illustrate different embodiments of the invention that are proposed in this application. It shall be understood by those skilled in the art that they are provided merely as illustrative samples, and shall not be constructed as limitation to the invention.

Embodiments of the present invention provide a multi-versioning memory configuration that is able to maintain multiple values per speculative thread for the same memory location, thereby to support both live-in pre-computation and execution of a body of a speculative thread. In addition, embodiments of the invention provide validation of input values that may be computed and used in the execution of the speculative thread.

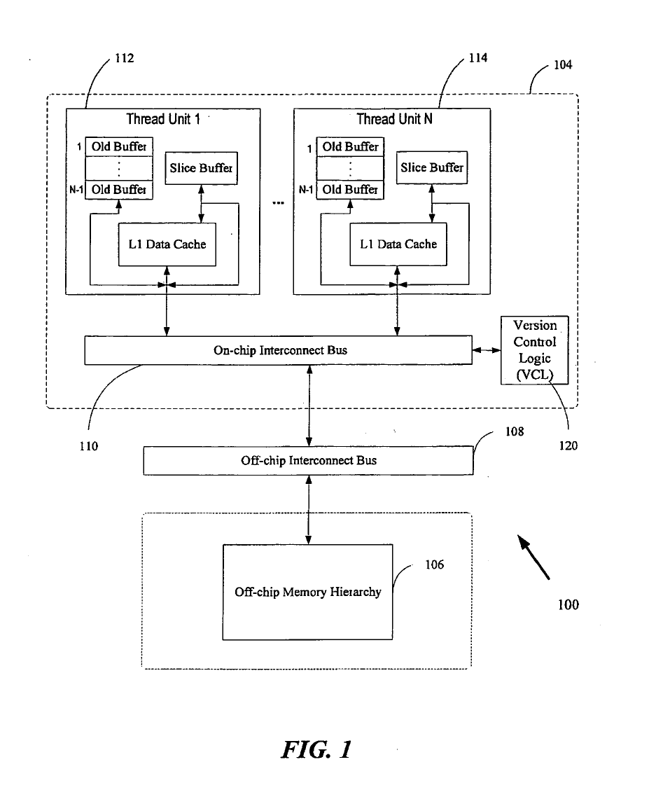

FIG. 1 is a block diagram illustration of an apparatus 100 adapted to execute a computer program code by speculative multithreading with live-in pre-computation according to illustrative embodiments of the invention. Apparatus 100 may include, for example, a processor 104, which may be implemented on a semiconductor device, operatively connected to a memory configuration, e.g., an off-chip memory hierarchy 106, via an interconnect bus 108. Processor 104 may include one or more thread units, for example, N thread units including thread units 112 and 114 to execute one or more threads. A thread unit may include on-chip memories, e.g., in the form of caches and/or buffers, and other desirable hardware. Thread units 112 and 114 may be operatively connected to a version control logic (VCL) unit 120 via an interconnect bus 110. VCL unit 120 may control reading and writing interaction between thread units, for example, thread units 112 and 114.

A non-exhaustive list of examples for apparatus 100 may include a desktop personal computer, a workstation, a server computer, a laptop computer, a notebook computer, a hand-held computer, a personal digital assistant (PDA), a mobile telephone, a game console, and the like.

A non-exhaustive list of examples for processor 104 may include a central processing unit (CPU), a digital signal processor (DSP), a reduced instruction set computer (RISC), a complex instruction set computer (CISC), and the like. Processor 104 may also be part of an application specific integrated circuit (ASIC), or may be part of an application specific standard product (ASSP).

Processor 104 may have incorporated hardware and technologies, for example, Intel® hyper-threading technology, and may support “thread-level parallelism” in processing multiple threads concurrently. Each thread unit, e.g., thread unit 112 or 114, of processor 104 may therefore be considered as a “virtual processor”, or core, as is known in the art, and each of units 112 and 114 may process threads separately.

A non-exhaustive list of examples for off-chip memory 106 may include one or any combination of following semiconductor devices, such as synchronous dynamic random access memory (SDRAM) devices, RAMBUS dynamic random access memory (RDRAM) devices, double data rate (DDR) memory structures, static random access memory (SRAM) devices, flash memory structures, electrically erasable programmable read only memory (EEPROM) devices, non-volatile random access memory (NVRAM) devices, universal serial bus (USB) removable memory, and the like; optical devices, such as compact disk read only memory (CD ROM), and the like; and magnetic devices, such as a hard disk, a floppy disk, a magnetic tape, and the like. Off-chip memory 106 may be fixed within or removable from apparatus 100

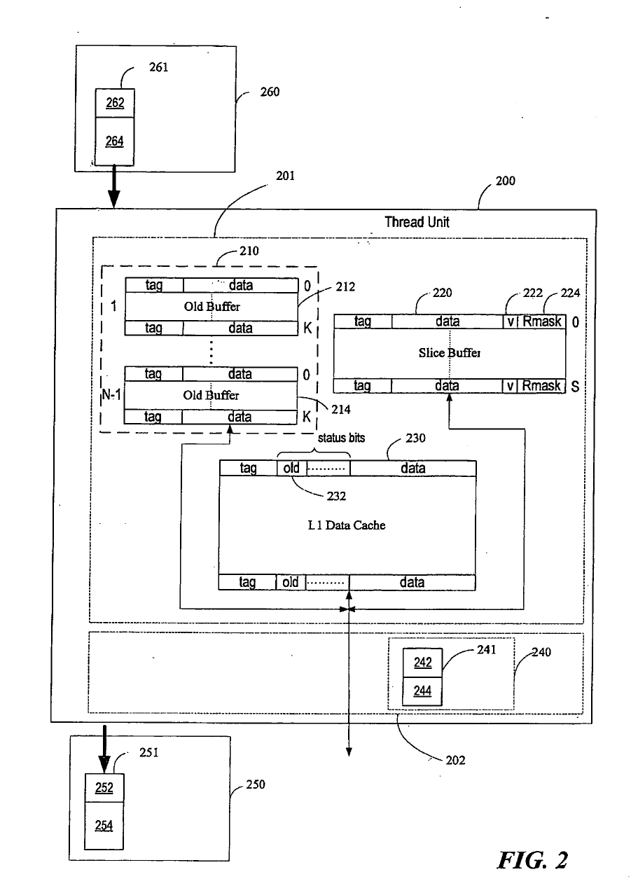

FIG. 2 is a block diagram illustration of a thread unit 200 having a memory configuration 201 and a processing unit 202. For purposes of example, FIG. 2 shows that processing unit 202 of thread unit 200 may include an instruction cache 240, which may execute a thread 241. FIG. 2 further illustrates a thread unit 250 to execute a thread 251. For purposes of discussion of the specific example shown in FIG. 2, it is assumed that thread 251 has been spawned by thread 241. FIG. 2 also illustrates an additional thread unit 260 to execute a thread 261. Again, for purposes of discussion, FIG. 2 shows an example that assumes that thread 261 has spawned thread 241, according to at least one embodiment of the invention. Memory configuration 201 may be a memory arrangement able to support multi-versioning, and may include a plurality of memory structures, for example, a memory structure 210 including one or more “Old buffers”, e.g., Old buffers 212 and 214. The memory configuration 201 may further include, a “Slice buffer” 220, and a “Level-1” (L1) data cache 230. The terms and details of “Old buffer”, “Slice buffer”, and “L-1 data cache” are described in the following sections. Although FIG. 2 illustrates three thread units, it will be appreciated by persons skilled in the art that embodiments of the invention may be implemented with more than three thread units or less than three thread units, in accordance with specific system requirements. Furthermore, it will be appreciated that the thread unit according to embodiments of the invention may execute speculative threads as well as non-speculative thread.

A memory structure, for example, Slice buffer 220 or L-1 data cache 230, may have multiple entries or lines. The term “line” or “entry” in this application, may refer to a granularity of memory unit operated by a processor or a thread unit, and may include several memory locations and data values.

Thread 251 may have a pre-computation slice 252 and a thread body 254. Thread 261 may have a pre-computation slice 262 and a thread body 264. Thread units 250 and 260, executing threads 251 and 261, may have memory configurations that are similar to thread unit 200 and therefore their details are not shown here for simple illustration purposes. Thread 241, executed by processing unit 202 of thread unit 200, may have a pre-computation slice 242 and a thread body 244. Thread 241 may be referred to as a local thread to thread unit 200.

Thread 241 may spawn thread 251, and therefore thread 241 may be a “parent thread” of thread 251, and thread 251 may be a “child thread” of thread 241. On the other hand, thread 241 may be spawned by thread 261 and therefore thread 261 may be a parent thread of thread 241, and thread 241 may be a child thread of thread 261 Pre-computation slice 252 of speculative thread 251 may read memory values generated by its spawning thread 241 at the time when speculative thread 251 was spawned. These memory values may be read by thread 251 from, for example, L-1 data cache 230 of thread unit 200. According to at least one embodiment of the invention, “store” operations performed by parent thread 241 to save updated values of L1 data cache, after the creation of child thread 251, may be made “invisible” to pre-computation slice 252 of child thread 251 by memory configuration 201. In other words, memory values at the time when child thread 251 was spawned may be preserved by memory configuration 201. According to at least one embodiment of the invention, store operations performed by parent thread 241 may be made available to thread body 254 of child thread 251 so that updated values of L1 data cache 230 may be used in the execution of thread body 254 of child thread 251.

The term “Old buffer”, in this application, may refer to a memory structure adapted to store values of other memories, for example, L1 data cache of a thread unit when a thread executed by the thread unit spawns one or more speculative threads. For example, when speculative thread 251 is spawned, Old buffer 212 may be allocated for the spawned thread 251, at thread unit 200 of the spawning thread 241.

According to illustrative embodiments of the invention, values stored in Old buffer 212 of thread unit 200 may be provided to pre-computation slice 252 of thread 251 for computing live-in input values to thread body 254. Thread unit 200 may have as many Old buffers as the number of child threads spawned by thread unit 200.

A thread unit may perform store operations on its memories, e.g., L1 data cache, during execution of a thread. For example, before writing new values onto a location of L1 data cache 230, thread unit 200 may store existing values at the location of L1 data cache 230 to memory structure 210 of Old buffers that have been allocated to spawned child thread 251 and other child threads. If values of the location of Ldata cache 230 have already been stored in memory structure 210 of Old buffers, then no duplicate backup is necessary and values in this L1 data cache location may be discarded. New values may then be overwritten onto the same location.

The term “Slice buffer”, in this application, may refer to a memory structure adapted to store live-in input values computed by pre-computation of a speculative thread. When a speculative thread is spawned, the spawned thread may be assigned, in a thread unit that executes the spawned speculative thread, with an empty Slice buffer. For example, thread 241 may be a speculative thread and when spawned by thread 261, thread unit 200 executing thread 241 may have assigned Slice buffer 220 to thread 241. Slice buffer 220 may include multiple entries. An entry may include, for example, a validity bit “V”, e.g., “V” bit 222, and a vector of read bits “Rmask”, e g., “Rmask” bits 224. “Rmask” bits 224 may contain as many bits as the number of thread units that exist in a processor, for example, processor 104 (FIG. 1). Functions of both the “V” bit and the “Rmask” bits are described below.

According to illustrative embodiments of the invention, pre-computation may write values to lines of the Slice buffer of a thread unit. For example, when a new line is written to Slice buffer 220 during execution of pre-computation slice 242 of thread 241, “V” bit 222 may be set to indicate that the line is valid. During execution of thread body 244 of thread 241 or other more speculative threads, values may be read from memory entries of Slice buffer 220. If the read is made by thread 241, local to thread unit 200, “V” bit 222 may be reset to invalidate the line being read which may then be copied to local L1 data cache 230. If the read is made by a different, more speculative, posterior thread, “V” bit 222 may not be reset, i.e., may be kept set, and the line is kept valid. In both cases, the corresponding read bit in “Rmask” bits 224 is used to indicate which thread has read the line.

Before a speculative thread becomes a non-speculative thread, entries in the Slice buffer of the thread may be validated by verifying whether the body of the thread has been executed with correct input values or whether a mis-speculation may have occurred during execution. This validation may be done as follows Entries of the Slice buffer that have any of their “Rmask” bits set may be sent to the previous non-speculative thread to validate their values. In situations where a mis-speculation has occurred, speculative posterior threads that may have referenced the Slice buffer entries of the thread and all of their successors may be squashed. After the speculative thread becomes non-speculative, e.g., committed, values stored in the Slice buffer may be cleared since they are potentially wrong. All local L1 data cache lines are committed.

L1 data cache 2.30 may include multiple “lines” of memories. A line of L1 data cache 230 may include a set of status bits including an “Old bit” 232. According to illustrative embodiments of the invention, thread 241 executing on thread unit 200 may perform a load to a line of L1 data cache 230 during pre-computation. When the value loaded is from an Old buffer of parent thread 261 allocated for thread 241 or from L1 data caches or Slice buffers of other remote threads that ate less speculative than parent thread 261, an Old bit of the line, e.g., Old bit 232, may be set to indicate that the line may contain potentially old values and may be discarded at the exit of the pre-computation slice.

According to illustrative embodiments of the invention, Old bits, e.g., Old bit 232, may be used to prevent a more speculative thread from reading old values from less speculative threads during execution of a pre-computation slice of the more speculative thread. When the pre-computation slice finishes, all the L1 cache entries with the Old bit set are invalidated to prevent values in the caches lines, which are potentially old, from being read by this thread and more speculative threads, as is described in detail below.

When a non-speculative thread finishes its execution, it may be possible that some of the child threads spawned by the non-speculative thread are still executing their respective pre-computation slices. Thus, according to illustrative embodiments of the invention, Old buffers of the non-speculative thread may not be freed until these child threads finish their pre-computation slices. When a speculative thread becomes a non-speculative one, it may send a request to its parent thread to de-allocate its corresponding Old buffer, as is described in detail below. When execution of a thread is completed and the thread is committed, the thread unit executing the committed thread may become idle and may be assigned to execute a new thread. Although the invention is not limited in this respect, the number of thread units in a processor, for example, processor 104 in FIG. 1, may be fixed.

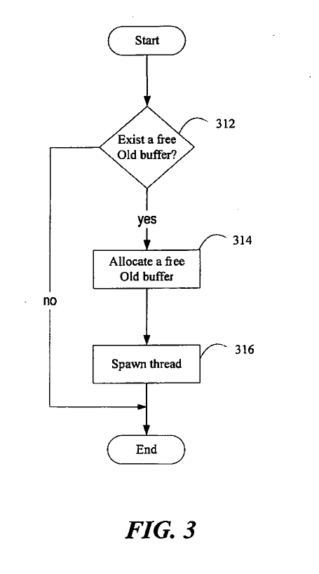

FIG. 3 is a schematic flowchart of a method of spawning a thread according to illustrative embodiments of the invention.

During thread execution, a thread unit may partition the thread it is executing into, or may spawn, one or more speculative threads for parallel processing. When a thread unit starts spawning, it may first determine, at block 312, whether there is a free Old buffer available for the thread to be spawned. If there are no free Old buffers available, the spawning may be aborted and the process terminated. If one or more free Old buffers are available, one of the Old buffers may be allocated at block 314. A thread, child thread, may then be spawned at block 316, and assigned the allocated Old buffer. The spawning process may then be terminated.

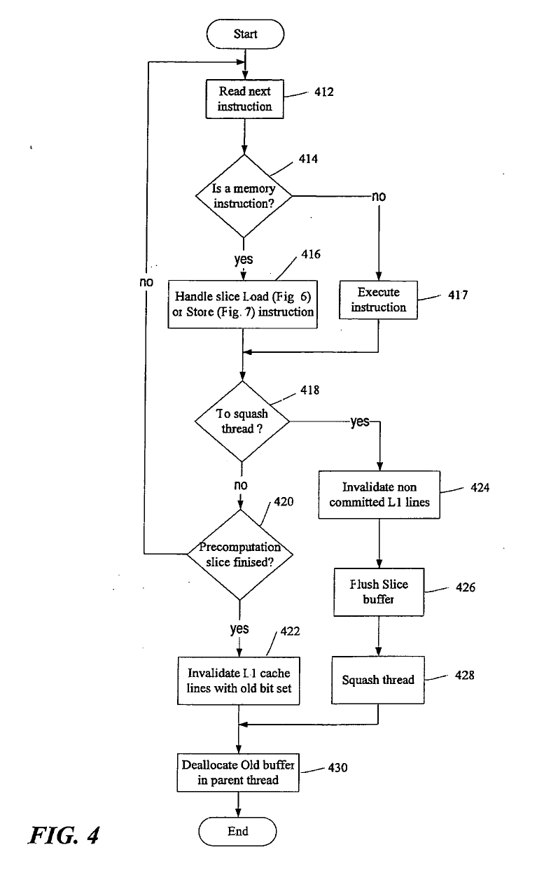

FIG. 4 is a schematic flowchart of a method of executing the pre-computation slice of a speculative thread according to illustrative embodiments of the invention.

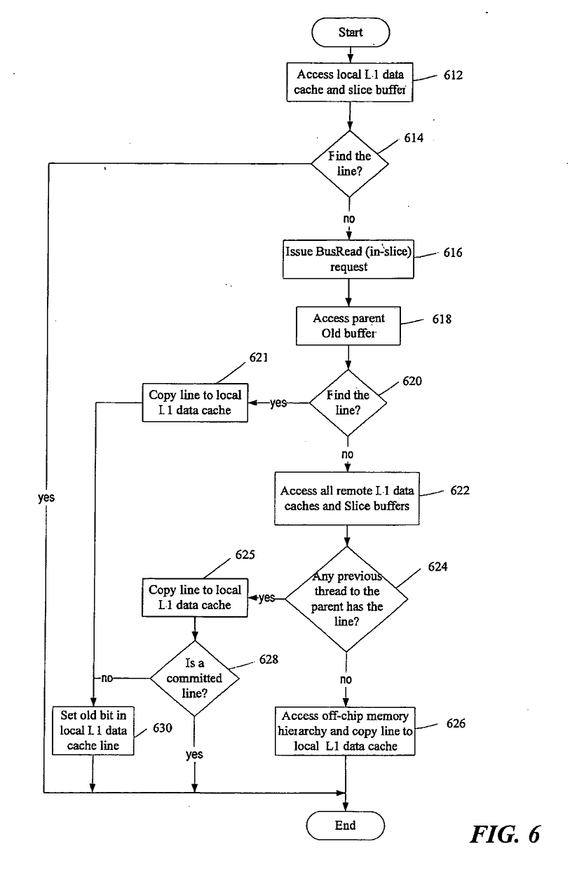

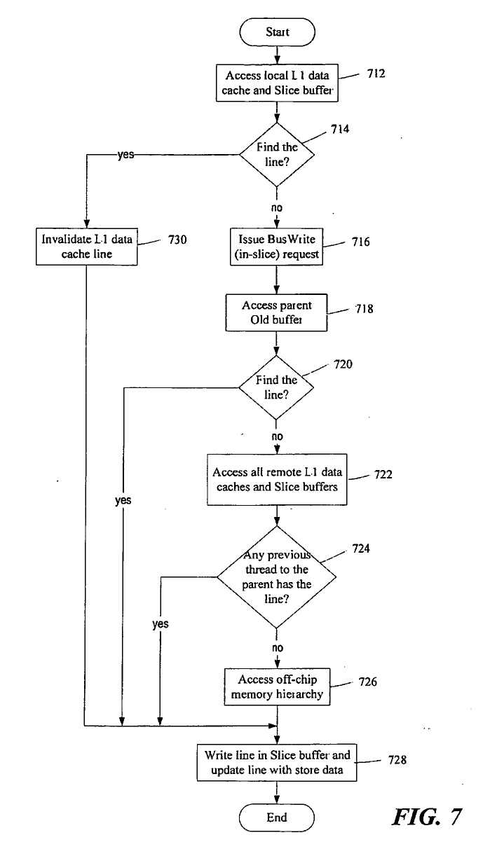

When one or more speculative threads are spawned, pre-computation slices of the threads in different thread units may be executed concurrently to compute live-in input values to their respective thread bodies. When a thread unit starts executing the pre-computation slice of a speculative thread, it may read an instruction, at block 412, from a local instruction cache or some external memory hierarchy. At block 414, if the instruction is a memory access instruction, such as a slice load or store instruction, the thread unit may execute the slice load or store instruction, at block 416, in a procedure that is defined in either FIG. 6 (for load instruction) or FIG. 7 (for store instruction) below. If the instruction is not a memory access instruction, it may be executed regularly at block 417.

At block 418, it may be determined whether the speculative thread under execution is instructed to be squashed, for example, by an instruction received. If the thread is to be kept, the thread unit may proceed to determine, at block 420, whether an end of the pre-computation slice has been reached. If there are more pre-computation instructions to be executed, the thread unit may return the execution process back to block 412 to read the next instruction, and the procedure described above may be repeated. If this is the end of the pre-computation slice, the thread unit may proceed to block 422 to invalidate lines of local L1 data cache whose Old bits have been set during the execution of slice load or store instructions (FIG. 6 or 7). At block 430, the thread unit may send a request to a thread unit that spawned the speculative thread under execution to de-allocate the Old buffer assigned to the speculative thread, which has just finished its pre-computation slice.

At block 418, if the speculative thread is determined to be squashed, the thread unit executing the speculative thread may proceed to block 424 to invalidate lines of local L1 data cache that are not committed. The thread unit may then proceed to block 426 to flush, e.g., clear, the Slice buffer of the thread unit, and to block 428 to squash, e.g, delete, the thread. The thread unit may further proceed to block 430 to send a request to the thread unit that spawned the speculative thread to de-allocate the Old buffer assigned to the speculative thread, which has just been squashed

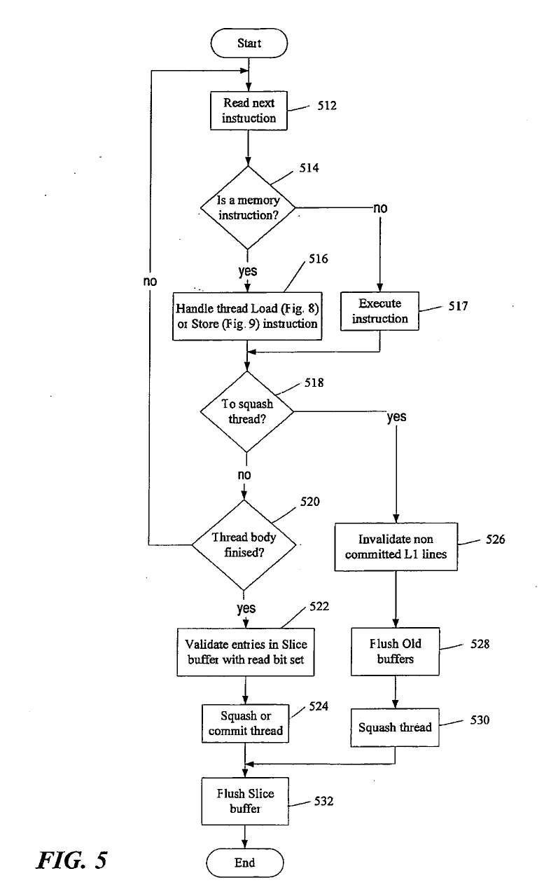

FIG. 5 is a schematic flowchart of a method of executing the thread body of a speculative thread according to illustrative embodiments of the invention.

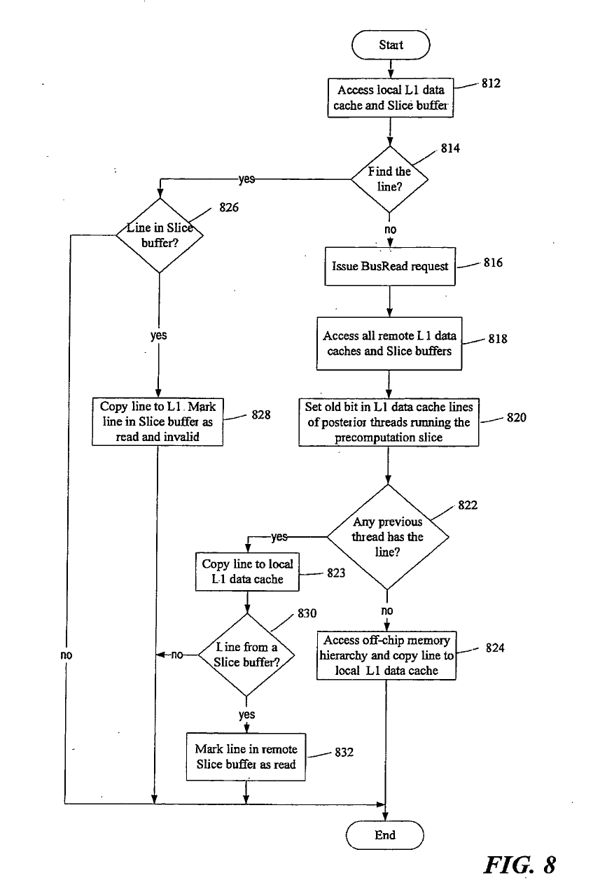

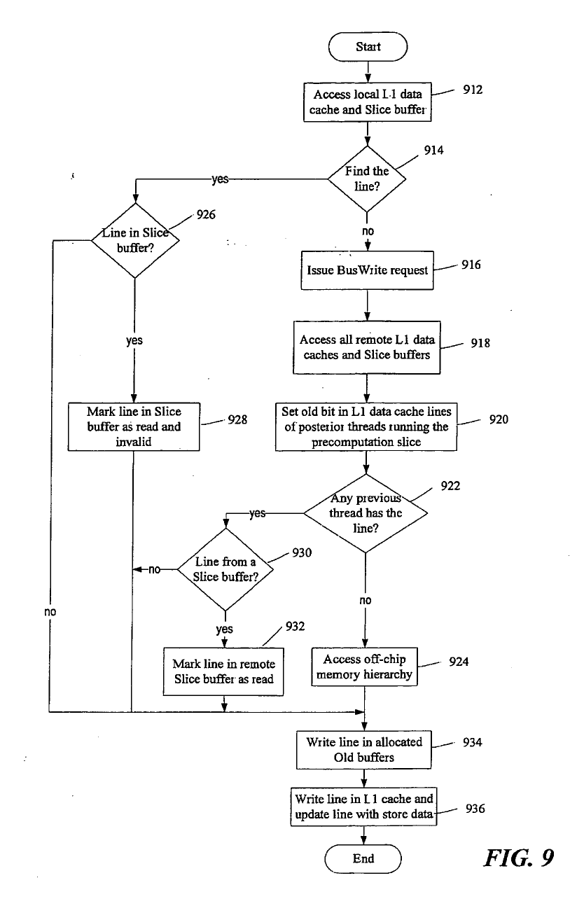

After live-in pre-computation of a speculative thread, a thread unit may start executing instructions of the body of the thread. The thread unit may read an instruction, at block 512, from a local instruction cache or some external memory hierarch. At block 514, if the instruction is a memory access instruction, such as a thread load or store instruction, the thread unit may execute the thread load or store instruction, at block 516, in a procedure that is defined in either FIG. 8 (for load instruction) or FIG. 9 (for store instruction) below. If the instruction is not a memory access instruction, it may be executed regularly at block 517.

At block 518, it is tested whether the speculative thread shall be squashed. If the thread is not be squashed, the thread unit may proceed to determine, at block 520, whether an end of the thread body has been reached. If there are more instructions in the thread body to be executed, the thread unit may continue to read the next instruction by returning the process to block 512, and the procedure described above may be repeated. If the end of the thread body has been reached, the thread unit may proceed to block 522 to validate the read entries, in the Slice buffer of the thread, whose read bits have been set during the execution of thread load or store instructions (FIG. 8 or 9). Based on validation of the read entries, the execution of thread body is either considered valid and therefore committed, or invalid and therefore squashed at block 524. The thread unit may then proceed to block 532 to flush, e.g., clear, entries in the Slice buffer of the thread unit.

A thread may be squashed when a squash signal is sent by VCL unit 120 in situations when a mis-speculation is detected, or sent by a less speculative thread for other reasons. If at block 518, it is determined that the thread shall be squashed, the thread unit running the thread may proceed, at block 526, to invalidate non-committed lines in the local L1 data cache and, at block 528, to de-allocate Old buffers of the thread unit, and then, at block 530, to squash the thread and terminate the execution. The thread unit may then proceed to block 532 to flush entries in the Slice buffer.

FIG. 6 is a schematic flowchart of a method of executing a load instruction in a pre-computation slice according to illustrative embodiments of the invention.

When a thread unit performs a load instruction in a pre-computation slice, it may access local L1 data cache and Slice buffer of the thread unit at block 612. At block 614, if it is determined that the memory line requested is available from either the local L1 data cache or the Slice buffer, i.e., the line is found locally, the load instruction is finished. Otherwise, the thread unit may proceed to block 616.

At block 616, the thread unit may issue an in-slice BusRead request to access a thread unit of the parent thread via on-chip interconnect bus 110 (FIG. 1). The in-slice request may be accompanied by a signal indicating that the thread that made the request, a child thread, is in a pre-computation slice mode and therefore the parent thread may return a line from an Old buffer allocated for the child thread and not from its L1 data cache. The Old buffer allocated at the parent thread unit may be accessed at block 618.

The thread unit of the parent thread may provide with a line from its allocated Old buffer at block 620. The line may be copied to the L1 data cache of the thread unit of the child thread at block 621. The Old bit of the line in the local L1 data cache may be set, at block 630, to indicate that values there may be old since they are copied from the thread unit of the parent thread. If at block 620 the thread unit of parent thread does not provide a line from the Old buffer allocated for the child thread, for example, in a situation when the parent thread has not written the line from its L1 data cache to the Old buffer, VCL unit 120 (FIG. 1) may access other L1 data caches and Slice buffers of remote threads, at block 622, that are less speculative than the parent thread, via on-chip interconnect bus 110 (FIG. 1). VCL unit 120 may treat the load instruction as an ordinary load, and consider the child thread requesting the line as having the same logical order as its parent thread.

At block 624, if it is determined that VCL unit 120 is able to allocate the line requested from a remote thread less speculative than the parent thread, it may proceed to copy the line to the L1 data cache of the thread unit at block 625. The thread unit may then proceed to determine, at block 628, whether the line copied is a committed line. If the line is a committed line, the load instruction is executed and finished. If it is not a committed line, the Old bit in the copied line of local L1 data cache may be set, at block 630, to indicate that the data there may potentially be old. At block 624, if it is determined that VCL unit 120 is unable to allocate the line requested, the thread unit may access an off-chip memory hierarchy 106 (FIG. 1), at block 626, via off-chip interconnect bus 108 (FIG. 1). The line obtained from off-chip memory 106 may be copied to the local L1 data cache.

FIG. 7 is a schematic flowchart of a method of executing a store instruction in a pre-computation slice according to illustrative embodiments of the invention.

When a thread unit executes a pre-computation slice and performs a store instruction, the data may be stored in the Slice buffer of the thread unit. According to illustrative embodiments of the invention, the line to be stored may first be placed in the Slice buffer and then updated with the store data. To access the requested line, a method similar to that of performing a load instruction (FIG. 6) may be followed.

When a thread unit performs a store instruction in a pre-computation slice, it may access local L1 data cache and Slice buffer of the thread unit at block 712. At block 714 if it is determined that the memory line requested is available from the local L1 data cache, then the line in the L1 data cache may be invalidated at block 730. The line is copied to the Slice buffer of the thread unit and updated with the store data at block 728. This data is invisible to other thread units as long as the pre-computation slice is still running. At block 714, if it is determined that the line is not available from either the local L1 data cache or the Slice buffer, i.e., the line is not found locally, the thread unit may process to block 716.

At block 716, the thread unit may issue an in-slice BusWrite request to access a thread unit of the parent thread via on-chip interconnect bus 110 (FIG. 1) The in-slice request may be accompanied by a signal indicating that the thread that made the request, a child thread, is in a pre-computation slice mode and therefore the parent thread may return a line from an Old buffer allocated for the child thread and not from its L1 data cache. The Old buffer allocated at the parent thread unit may be accessed at block 718.

The thread unit of the patent thread unit may provide a line from its allocated Old buffer at block 720. The line may be copied to the Slice buffer of the thread unit of the child thread and updated with the store data at block 728. This data is invisible to other thread units as long as the pre-computation slice is still running If at block 720 the thread unit of parent thread does not provide a line from the Old buffer allocated for the child thread, for example, in a situation when the parent thread has not written the line from its L1 data cache to the Old buffer, VCL unit 120 (FIG. 1) may access other L1 data caches and Slice buffers of remote threads, at block 722, that are less speculative than the parent thread, via on-chip interconnect bus 110 (FIG. 1). VCL unit 120 may treat the store instruction as an ordinary store, and consider the child thread requesting the line as having the same logical order as its parent thread.

At block 724, if it is determined that VCL unit 120 is able to allocate the line requested from a remote thread less speculative than the parent thread, it may proceed to copy the line to the Slice buffer of the thread unit and update it with the store data at block 728. This data is invisible to other thread units as long as the pre-computation slice is still running. At block 724, if it is determined that VCL unit 120 is unable to allocate the line requested, the thread unit may access an off-chip memory hierarchy 106 (FIG. 1), at block 726, via off-chip interconnect bus 108 (FIG. 1). The line obtained from off-chip memory 106 may be copied to the Slice buffer of the child thread and updated with the store data at block 728. This data is invisible to other thread units as long as the pre-computation slice is still running.

FIG. 8 is a schematic flowchart of a method of executing a load instruction in the thread body of a speculative thread according to illustrative embodiments of the invention.

When a thread unit executing the thread body of a speculative thread performs a load instruction, it may first access memory locations of the Slice buffer and L1 data cache of the thread unit at block 812. At block 814, if it is determined that the line requested is available, the thread unit may proceed to determine, at block 826, whether the line is available from the Slice buffer. If the line is available from the Slice buffer, it is then copied to the L1 data cache of the thread unit at block 828 The line that supplies the data in the Slice buffer is marked as read by the corresponding read bit in the “Rmask” and as invalid by resetting the valid bit “V” (FIG. 2). All lines in the Slice buffer with any read bit set are later validated before the thread becomes non-speculative. At block 826, if it is determined that the line is available from the local L1 data cache, the load instruction is then finished.

At block 814, if it is determined that the line is not available from either the Slice buffer or the L1 data cache of the thread unit, i.e., the line is not found locally, the thread unit may issue a BusRead request, at block 816, to VCL unit 120 via on-chip interconnect bus 110 (FIG 1). VCL unit 120 may access other L1 data caches and Slice buffers of less speculative, remote threads at block 818. VCL unit 120 may also set the Old bit on the L1 data cache lines of threads that are more speculative than the current thread and are still running pre-computation slices, at block 820, to indicate that the data there may be old

At block 822, if VCL unit 120 is able to allocate the tight version of the line requested from threads that are less speculative than the thread under execution, it may copy the line to the L1 data cache of the thread unit at block 823. The thread unit may proceed to determine, at block 830, whether a remote Slice buffer provided the line. If it is, then the line in the remote Slice buffer is marked as read and indicates which thread unit has read the line, at block 832, by using a read bit of “Rmask” of the remote Slice buffer. All lines in the Slice buffer with any read bit set are validated before the thread under execution becomes non-speculative. At block 822, if VCL unit 120 is unable to allocate the line, then the thread unit may access an off-chip memory hierarchy 106, at block 824, via an off-chip interconnect bus 108 (FIG. 1). The line obtained from the off-chip memory 106 is then copied, at block 824, to the local L1 data cache of the thread unit.

FIG. 9 is a schematic flowchart of a method of executing a store instruction in the thread body of a speculative thread according to illustrative embodiments of the invention.

When a thread unit executing the thread body of a speculative thread performs a store instruction, a memory line requested may be first placed in the local L1 data cache of the thread unit and then updated with the store data. To access the requested line, a method similar to that of performing a load instruction (FIG. 8) may be followed according to illustrative embodiments of the invention.

The thread unit may first access memory locations of the Slice buffer and L1 data cache of the thread unit at block 912. At block 914, if it is determined that the line requested is available, the thread unit may proceed to determine, at block 926, whether the line is available from the Slice buffer. If it is available from the Slice buffer, the line that supplies the data in the Slice buffer is then marked as read by a read bit of “Rmask” and as invalid by resetting the valid bit at block 928. At block 926, if it is determined that the line is not available from the Slice buffer, it is then available from the local L1 data cache. In both above cases, the line is copied to Old buffers, at block 934, that are allocated in the thread unit to save old memory values for child threads that are spawned by the thread unit and are executing pre-computation slices. The line is then copied to the local L1 data cache of the thread unit and updated with the store data at block 936

At block 914, if it is determined that the line is not available from either the Slice buffer or the L1 data cache of the thread unit, i.e, the line is not found locally, the thread unit may issue a BusWrite request, at block 916, to VCL unit 120 via on-chip interconnect bus 110 (FIG. 1) VCL unit 120 may access other L1 data caches and Slice buffers of less speculative, remote threads at block 918. VCL unit 120 may also set the Old bit of L1 data cache lines of threads that are more speculative than the current thread and are still running pre-computation slices, at block 920, to indicate that the data there may be old.

At block 922, if VCL unit 120 is able to allocate the right version of the line requested, it may proceed to determine, at block 930, whether a remote Slice buffer provided the line. If it is, then the line in the remote Slice buffer is marked as read and indicated which thread unit has read the line, at block 932, by using a read bit of “Rmask” of the remote Slice buffer. All lines in the Slice buffer with any read bit set are validated before the thread under execution becomes non-speculative. At block 922, if VCL unit 120 is unable to allocate the line, then the thread unit may access off-chip memory hierarchy 106, at block 924, via an off-chip interconnect bus 108 (FIG. 1). In both above cases, the line is copied to Old buffers, at block 934, that are allocated in the thread unit to save old memory values for child threads that are spawned by the thread unit and are executing pre-computation slices. The line is then copied to the local L1 data cache of the thread unit and updated with the store data at block 936.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. An apparatus comprising: a processor including at least one thread unit to execute a first thread, said thread unit having an Old buffer allocated to store values for execution of a second thread that was spawned by said first thread, wherein said values for execution of the second thread correspond to values of the first thread from the time of spawning of the second thread.

2. The apparatus of claim 1, wherein said thread unit further comprises: a Slice buffer to store live-in input values computed by executing a pre-computation slice of said first thread based on values of a third thread that spawned the first thread.

3. The apparatus of claim 2, wherein said values of the third thread correspond to values from the time the third thread spawned the first thread.

4. The apparatus of claim 2, wherein said thread unit further comprises: a Level-1 data cache to load values from said first and third threads during execution of said pre-computation slice of the first thread.

5. The apparatus of claim 4, wherein said Level-1 data cache includes at least one old-bit to mark values loaded from said third thread as potentially old during said execution of said pre-computation slice for said live-in input values, and wherein said thread unit is able to discard said marked values after said thread unit executes said pre-computation slice.

6. The apparatus of claim 2, wherein said Slice buffer has one or more read-bits to record a reading of values of said Slice buffer by either or both of said first and second threads, and at least one validity bit to mark valid values of the Slice buffer.

7. The apparatus of claim 2, wherein said thread unit is able to: determine whether said live-in input values are valid by comparing said live-in input values to updated values of said third thread; commit said first thread if said live-in input values are valid; and discard said first thread if said live-in input values are invalid.

8. The apparatus of claim 1, wherein said at least one thread unit comprises at least first and second thread units, and wherein said first thread unit is able to de-allocate said Old buffer allocated for said second thread after said second thread unit executes a pre-computation slice of said second-thread.

9. The apparatus of claim 1, further comprising: a version control logic unit operatively associated with said first and second thread units and able to control reading and writing interaction between said first and second thread units.

10. A method comprising: executing a first thread; and storing values for execution of a second thread that was spawned by said first thread, which values correspond to values of the first thread from the time of spawning of the second thread.

11. The method of claim 10, further comprising: storing live-in input values computed by executing a pre-computation slice of said first thread based on values of a third thread that spawned the first thread.

12. The method of claim 11, wherein said values of the third thread correspond to values from the time the third thread spawned the second thread.

13. The method of claim 11, comprising: loading values from said first and third threads during execution of said pre-computation slice of said first thread.

14. The method of claim 13, comprising: marking values loaded from said third thread as potentially old during said execution of said pre-computation slice for said live-in input values; and discarding said marked values after executing said pre-computation slice.

15. The method of claim 11, comprising: recording a reading of said live-in input values by either or both of said first and second threads; and marking values of said live-in input values that are valid.

16. The method of claim 11, comprising: determining whether said live-in input values are valid by comparing said live-in input values to updated values of said third thread; committing said first thread if said live-in input values are valid; and squashing said first thread if said live-in input values are invalid.

17. The method of claim 10, further comprising: de-allocating a memory allocated for said second thread after executing a pre-computation slice of said second thread.

18. A system comprising: a processor having one or more thread units and a version-control-logic unit to control reading and writing interaction between said one or more thread units: and an off-chip memory operatively connected to said processor, wherein at least one of the thread units of said processor is able to execute a first thread, said thread unit having an Old buffer allocated to store values for execution of a second thread that was spawned by said first thread, wherein said values for execution of the second thread correspond to values of the first thread from the time of spawning of the second thread.

19. The system of claim 18, wherein said thread unit further comprises: a Slice buffer to store live-in input values computed by executing a pre-computation slice of said first thread based on values of a third thread that spawned the first thread.

20. The system of claim 19, wherein said values of the third thread correspond to values from the time the third thread spawned the first thread.

21. The system of claim 19, wherein said thread unit further comprises: a Level-1 data cache to load values from said first and third threads during execution of said pre-computation slice of the first thread.

22. The system of claim 21, wherein said Level-1 data cache includes at least one old-bit to mark values loaded from said third thread as potentially old during said execution of said pre-computation slice for said live-in input values, and wherein said thread unit is able to discard said marked values after said thread unit executes said pre-computation slice.

23. The system of claim 19, wherein said Slice buffer has one or more read-bits to record a reading of values of said Slice buffer by either or both of said first and second threads, and at least one validity bit to mark valid values of the Slice buffer.

24. The system of claim 19, wherein said thread unit is able to: determine whether said live-in input values are valid by comparing said live-in input values to updated values of said third thread; commit said first thread if said live-in input values are valid; and discard said first thread if said live-in input values are invalid.

25.-29. (canceled)
